(19) United States
(12) Patent Application Publication
(10) Pub. No.: US 2024/0191728 A1
(43) Pub. Date: Jun. 13, 2024

(54) Hydraulic Pump

(71) Applicant: Milwaukee Electric Tool Corporation, Brookfield, WI (US)

(72) Inventors: Jonathan Kriefall, Brookfield, WI (US); Sebastian Quesada, Brookfield, WI (US); Chad Tarman, Brookfield, WI (US)

(21) Appl. No.: 18/537,447

(22) Filed: Dec. 12, 2023

Related U.S. Application Data
(60) Provisional application No. 63/387,084, filed on Dec. 12, 2022.

(51) Int. Cl. F15B 11/16

(52) U.S. Cl. CPC F15B 11/165; F15B 2211/20546; F15B 2211/7053

(57) ABSTRACT

A hydraulic pump is provided including a housing with a work port, a bladder that stores hydraulic fluid, a pump assembly, and a manifold. The pump assembly pumps hydraulic fluid from the bladder to the work port via an outlet line. The manifold includes a first chamber, a first relief valve, a second chamber located between the first chamber and the work port, a second relief valve, and a check valve. The first relief valve releases fluid from the outlet line to the bladder when a first pressure is reached within the first chamber. The second relief valve releases fluid from the outlet line to the bladder when a second pressure is reached within the second chamber. The check valve is positioned along the outlet line between the first chamber and the second chamber and prevents fluid flow from the second chamber to the first chamber.

### RELATED APPLICATIONS

This application claims priority under 35 U.S.C. § 119 to U.S. Provisional Patent Application No. 63/387,084 filed on Dec. 12, 2022, the entire contents of which is incorporated herein by reference.

### FIELD

The present disclosure relates generally to hydraulic pumps and systems, and more particularly to systems and methods for a single acting, cordless hydraulic pump for use with a hydraulic tool.

### BACKGROUND

Hydraulic tools can be used to provide an operator with a mechanical advantage for performing work on a workpiece. For example, a hydraulic tool may be a cutting device having blades for cutting an object into separate parts. As another example, a hydraulic tool may be a crimping device for making crimping connections, thereby conjoining two separate pieces by deforming one or both pieces in a way that causes them to hold together. As yet another example, a hydraulic tool may be a lifting cylinder for lifting a workpiece and/or a pipe bender for bending a workpiece.

In general, a hydraulic tool is coupled to a hydraulic pump, which is operable to pressurize a hydraulic fluid. The hydraulic pump transfers the pressurized hydraulic fluid to a cylinder in the hydraulic tool, and the hydraulic tool uses the pressurized hydraulic fluid from the hydraulic pump to perform the work, e.g., crimping, cutting, lifting, etc. The hydraulic pump, therefore, requires mechanisms to pressurize the hydraulic fluid, maintain the pressure, and release the pressure.

### SUMMARY

In some aspects, a hydraulic pump is provided. The hydraulic pump includes a housing with a work port, a bladder that stores hydraulic fluid, a pump assembly, and a manifold. The pump assembly pumps hydraulic fluid from the bladder to the work port via an outlet line. The manifold contains a portion of the outlet line and includes a first chamber, a first relief valve, a second chamber located between the first chamber and the work port, a second relief valve, and a check valve. The first relief valve is connected to the first chamber and releases fluid from the outlet line to the bladder when a first pressure is reached within the first chamber. The second relief valve is connected to the second chamber and releases fluid from the outlet line to the bladder when a second pressure is reached within the second chamber. The check valve is positioned along the outlet line between the first chamber and the second chamber and prevents fluid flow from the second chamber to the first chamber.

In another aspect, a single acting hydraulic pump is provided. The pump includes a housing including a work port, a trigger located on the housing, a bladder that stores hydraulic fluid, a pump assembly that pumps the hydraulic fluid from the bladder to the work port, a motor that operates the pump assembly, and a pump controller that controls the motor. The trigger is configured to travel between an undepressed state and a fully depressed state by an operator. The pump controller controls a speed of the motor by operating the motor at a percentage of full motor power correlating to a percentage of trigger travel between the undepressed state and the fully depressed state.

In yet another aspect, a method of operating a single acting hydraulic pump is provided. The method includes determining a percentage of trigger travel between an undepressed state and a fully depressed state when an operator depresses a trigger on the single acting hydraulic pump, and operating a pump assembly to pump hydraulic fluid from a bladder to a work port of the single acting hydraulic pump when the operator depresses the trigger. Operating the pump assembly includes controlling a motor that drives the pump assembly at a percentage of full motor power, where the percentage of full motor power correlates to the percentage of trigger travel between the undepressed state and the fully depressed state.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and descriptions thereof, will best be understood by reference to the following detailed description of an illustrative embodiment of the present disclosure when read in conjunction with the accompanying drawings, wherein:

FIG. 1 is a schematic diagram of a hydraulic power tool system including a hydraulic pump according to some embodiments;

FIG. 2 is an isometric view of a hydraulic pump according to some embodiments;

FIG. 3 is another isometric view of the hydraulic pump of FIG. 2, connected to a hydraulic tool;

FIG. 4 is a partial cross-sectional view of the hydraulic pump of FIG. 2;

FIG. 5 is a flow diagram of an open-loop motor speed control method according to some embodiments;

FIG. 6 is a flow diagram of a closed-loop motor speed control method according to some embodiments; and

FIG. 7 is a hydraulic schematic view of a hydraulic power tool system including a hydraulic pump according to some embodiments.

### DETAILED DESCRIPTION

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

As used herein, unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Generally, some embodiments provide a single acting, battery operated, hydraulic pump for use with a hydraulic tool. The hydraulic pump can include a variable speed motor and a pump controller configured to control the variable speed motor using open loop control based on a percentage of motor power applied or using closed loop control based on actual motor speed. Furthermore, the hydraulic pump can include a manifold with an overpressure protection system including dual chambers with respective relief valves and a check valve therebetween. The overpressure protection system can release pressurized fluid back to the hydraulic pump's bladder to prevent pump overpressure events as well as external load overpressure events.

Disclosed embodiments will now be described more fully hereinafter with reference to the accompanying drawings, in which some, but not all of the disclosed embodiments are shown. Indeed, several different embodiments may be provided and should not be construed as limited to the embodiments set forth herein. Rather, these embodiments are provided so that this disclosure will be thorough and complete and will fully convey the scope of the disclosure to those skilled in the art.

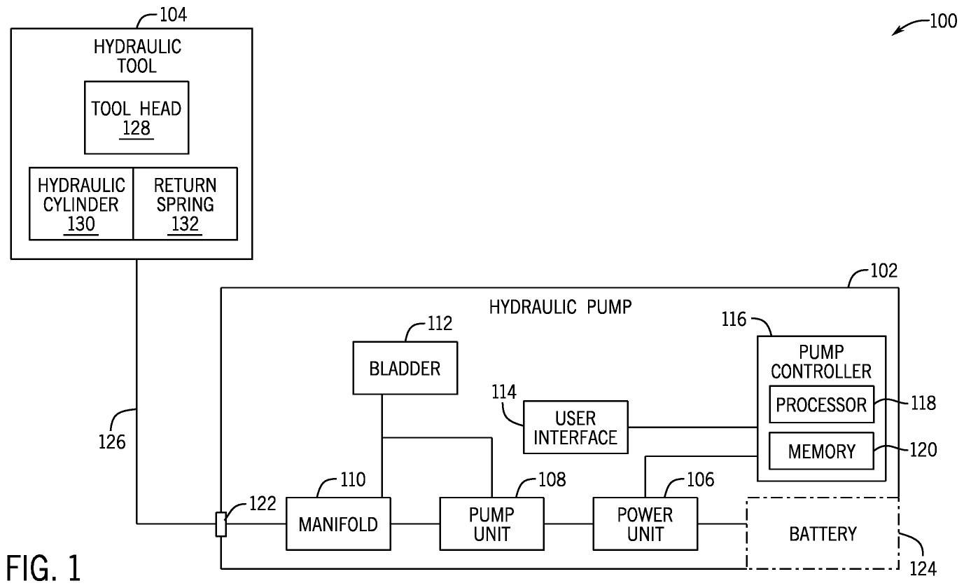

FIG. 1 illustrates a hydraulic power tool system 100 including a hydraulic pump 102, according to some embodiments, and a hydraulic tool 104. Generally, the hydraulic pump 102 can be operated to provide a pressurized fluid (e.g., a hydraulic oil) to actuate the hydraulic tool 104. For example, as shown in FIG. 1, the hydraulic pump 102 can include a power unit 106, a pump assembly 108, a manifold 110, a bladder 112, a user interface 114, a pump controller 116 with a processor 118 and memory 120, a work port 122, and a removable power source or battery 124. Alternatively, in some embodiments, the battery 124 may be a non-removable power source configured to be recharged while remaining attached to the hydraulic pump 102. The hydraulic pump 102 can be removably coupled to the hydraulic tool 104 via a fluid supply line 126, such as tubing, extending from the work port 122. Furthermore, the hydraulic tool 104 can include a tool head 128, a hydraulic cylinder 130, and a return spring 132.

In operation, the power unit 106 can be powered by the battery 124 and controlled by the pump controller 116, in response to user input from the user interface 114, to drive the pump assembly 108. The pump assembly 108 pumps pressurized fluid from the bladder 112 through the manifold 110 and the fluid supply line 126 to the hydraulic tool 104. Within the hydraulic tool 104, the pressurized fluid pushes the hydraulic cylinder 130, which actuates the tool head 128. For example, the tool head 128 may include a set of jaws (not shown), and the hydraulic cylinder 130 includes a piston (not shown) that moves one or both jaws toward each other, causing a crimping or cutting operation. In another example, the tool head 128 includes a movable lift structure (not shown), and the hydraulic cylinder 130 moves the movable lift structure to change an elevation of a workpiece supported by the movable lift structure. Other examples are possible such as, but not limited to, tool heads 128 with moveable elements (e.g., a bend die and/or a bend roll) that can move a workpiece relative to a stationary element (e.g., a stationary die and/or a stationary roll) to change a shape of the workpiece.

Once an operation is completed, the return spring 132 can force the fluid from the hydraulic tool 104 back through the fluid supply line 126, and back into the hydraulic pump 102. In this manner, the hydraulic pump 102 is a single action pump. That is, the hydraulic pump 102 includes a single work port 122 and forces fluid in one direction, and the hydraulic tool 104 includes a spring 132, or gravity or another external force, to return the fluid back to the hydraulic pump 102. As a result, the external force, e.g., the spring 132, rather than the hydraulic tool 104 or a user, releases pressure within the hydraulic tool 104 to force the fluid back into the hydraulic pump 102.

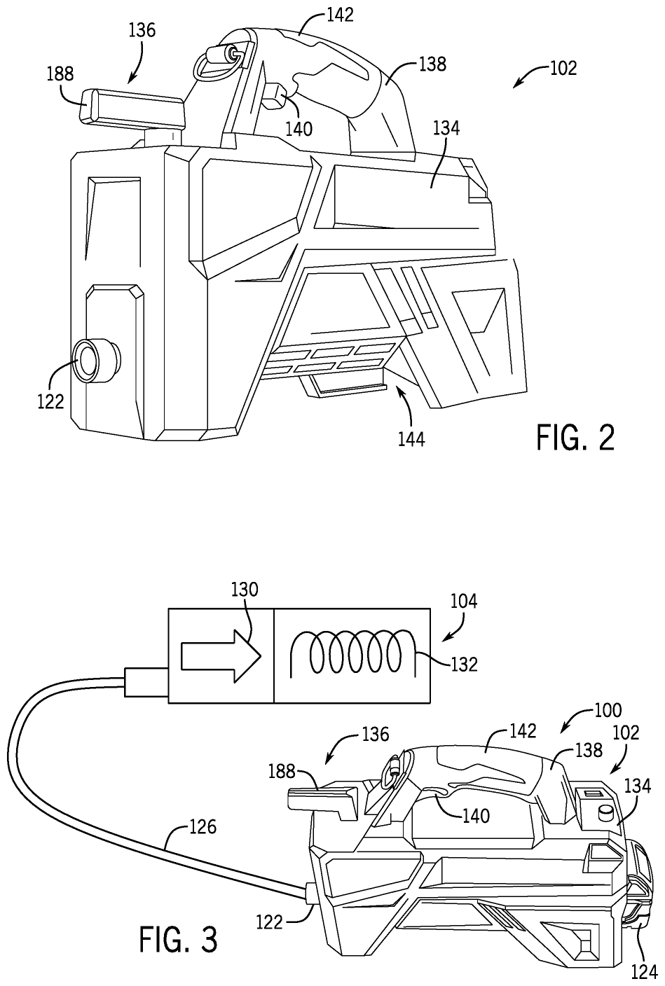

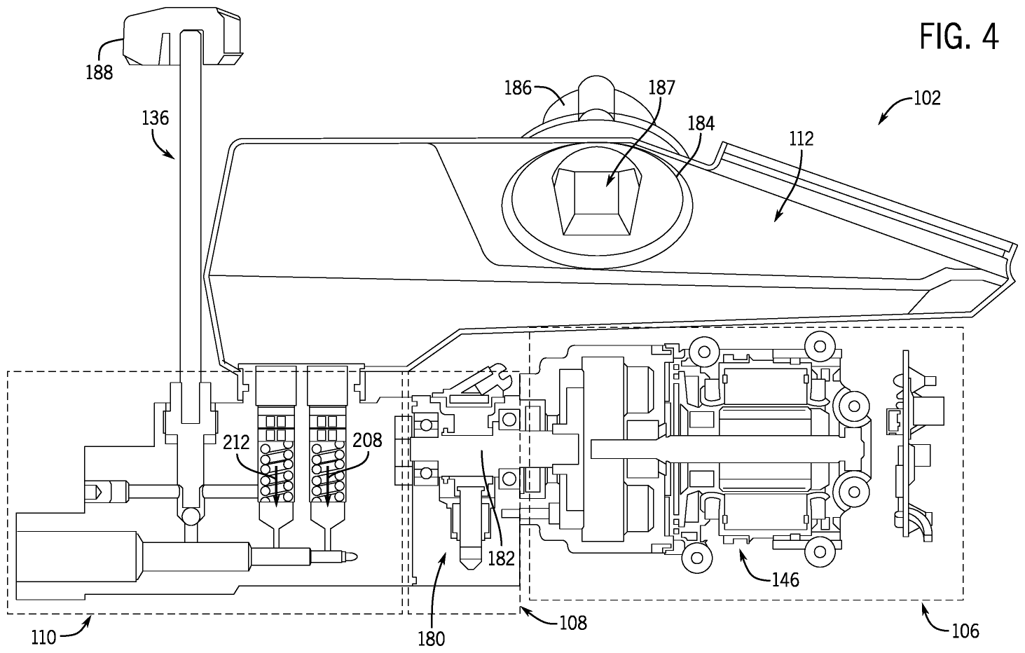

FIGS. 2-4 further illustrate the hydraulic pump 102 according to some embodiments. As shown in the external views of FIGS. 2 and 3, the hydraulic pump 102 can include a housing 134, the work port 122, a release valve 136, a handle 138, a trigger 140, a lock 142, and a battery terminal 144. The partial internal view of FIG. 4 illustrates the power unit 106, the pump assembly 108, the manifold 110, the bladder 112, and the release valve 136.

Referring to FIGS. 1 and 4, the power unit 106 can include a motor 146 configured to convert electrical energy to rotational motion in order to operate the pump assembly 108. In some embodiments, the power unit 106 can comprise a variable speed motor 146. Further, in some embodiments, the power unit 106 can comprise a brushless direct current (DC) motor 146 with a planetary gearset.

The power unit 106 can be powered by a power source, such as the battery 124, as shown in FIG. 1. The hydraulic pump 102 can, therefore, be considered a cordless pump as it is battery operated. In some embodiments, the battery 124 can be an 18-volt battery. Furthermore, in some embodiments, the battery 124 can be removable from the hydraulic pump 102. For example, as shown in FIG. 2, the hydraulic pump 102 can include the battery terminal 144, onto which the battery 124 can be removably coupled. As a result, the battery 124 can be removed from the hydraulic pump 102 and recharged and/or replaced, when necessary.

Furthermore, the power unit 106 can be controlled by the pump controller 116. As such, the pump controller 116 can be in communication with the motor 146. The pump controller 116 can be implemented using hardware, software, and/or firmware. For example, as shown in FIG. 1, the pump controller 116 can include one or more processors 118 and memory 120, e.g., a non-transitory computer readable memory that stores machine language instructions or other executable instructions. The instructions, when executed by the one or more processors 118, can cause the pump controller 116 to carry out various operations of the hydraulic pump 102. Additionally or alternatively, the pump controller 116 can include one or more relays, switches, or other hardware components to carry out various operations of the hydraulic pump 102.

For example, in some embodiments, the memory 120 can include instructions that, when executed by the processor(s) 118, cause the pump controller 116 to operate the electric motor 146 in response to user input from an operator. Such user input can be the operator depressing the trigger 140. As shown in FIGS. 2 and 3, the trigger 140 can be located along the handle 138 of the pump housing 134, allowing an operator to grasp the handle 138 and actuate the trigger 140. However, in other embodiments, the trigger 140 may be located elsewhere along the housing 134.

In some embodiments, the trigger 140 may act as an on-off switch, such that the pump controller 116 turns on and runs the motor 146 to operate the pump assembly 108 when the trigger 140 is depressed, and turns off the motor 146 when the trigger 140 is released. In other embodiments, as further described below, the trigger 140 may be a variable trigger 140 such that the pump controller 116 controls a speed of the motor 146 in direct relation to an amount of force applied to the trigger 140, or an amount of trigger travel (i.e., between an undepressed state and a fully depressed state). In such embodiments, the pump controller 116 can still turn off the motor 146 when the trigger 140 is no longer depressed. Additionally, in some embodiments, the hydraulic pump 102 can include additional user input to prevent electric motor operations. For example, as shown in FIGS. 2 and 3, the hydraulic pump 102 can include a lock 142, such as on the handle 138, that prevents accidental trigger 140 pulls. In some embodiments, the lock 142 can be a mechanical lock that prevents the trigger 140 from being depressed. In other embodiments, the lock 142 can be an electronic lock that, when actuated, sends a signal to the pump controller 116 to prevent motor operation regardless of input received through the trigger 140.

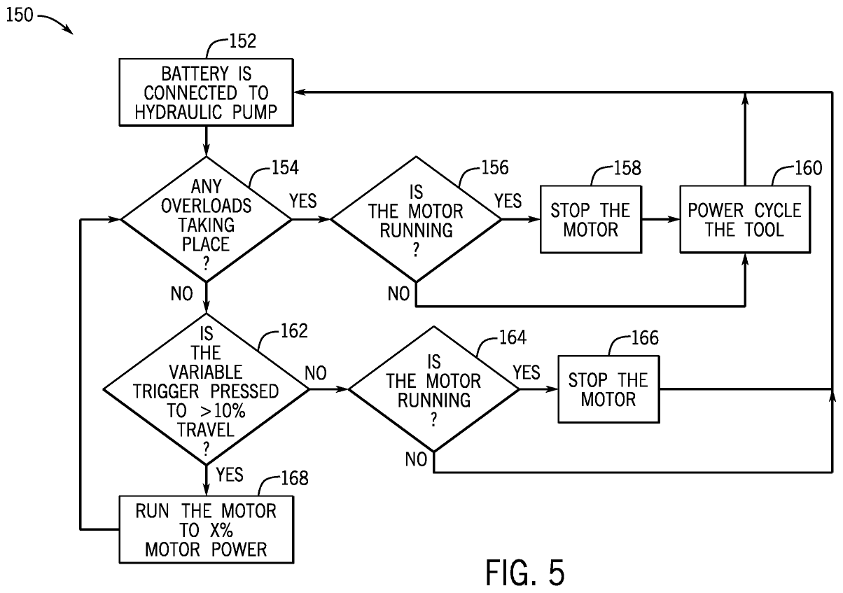

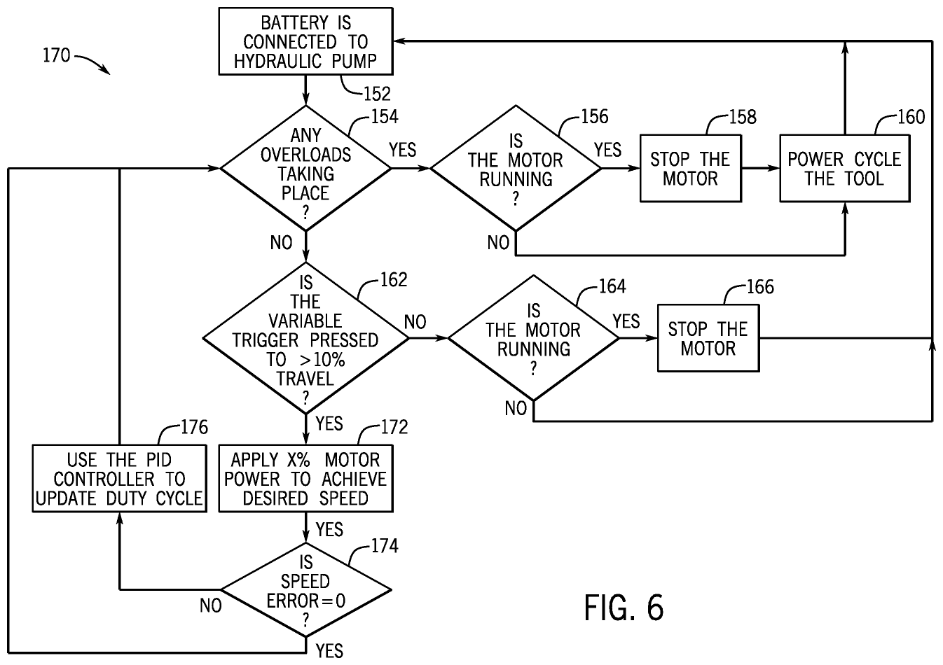

As noted above, in some embodiments, the pump controller 116 can operate the motor 146 at variable speeds, for example, in relation to an operator's force applied to the trigger 140 or an amount of trigger travel. For example, FIGS. 5 and 6 illustrate methods of variable motor speed control according to some embodiments. In some embodiments, the methods of FIGS. 5 and 6 can executed by the pump controller 116 (e.g., can be stored in the memory 120 to be executed by the processor 118 of the pump controller 116). It should be noted that, while certain steps are illustrated in FIGS. 5 and 6 and described below in a particular order, in some embodiments, the steps may be executed in a different order than that shown and described, or more or fewer steps may be executed.

For example, FIG. 5 illustrates an open-loop variable speed motor control method 150 according to some embodiments. Generally, the open-loop method 150 of FIG. 5 is executed by varying percent motor power. More specifically, at step 152, a battery 124 is connected to the hydraulic pump 102, thus supplying power to the hydraulic pump 102. At step 154, the pump controller 116 determines whether any overloads are taking place. For example, an overload may be detected when the motor 146 is drawing current above a threshold value. As another example, an overload may be detected when a temperature of the motor 146 exceeds a threshold value.

If an overload is detected, as determined at step 154, the pump controller 116 determines if the motor 146 is running at step 156. If so, the pump controller 116 stops the motor 146 at step 158. If not, or following the pump controller 116 stopping the motor 146 at step 158, the pump controller 116 power cycles the hydraulic pump 102 at step 160. According to one example, the pump controller 116 may conduct a power cycling operation by disconnecting the battery 124 from the motor 146 and then reconnecting the battery 124 and the motor 146. After power cycling at step 160, the pump controller 116 returns to step 152.

Returning back to step 154, if an overload is not detected, the pump controller 116 determines whether the variable trigger 140 is pressed to greater than about 10% of its total travel at step 162 (e.g., the “total travel” being a fully depressed state). If not, the pump controller 116 determines if the motor 146 is running at step 164. If so, the pump controller 116 stops the motor 146 at step 166. If not, or following the pump controller 116 stopping the motor 146 at step 166, the pump controller 116 returns to step 152.

Returning back to step 162, if the variable trigger 140 is pressed to greater than about 10% of its total travel, the pump controller 116 operates the motor 146 at a percentage motor power that correlates to the percentage travel of the variable trigger 140 at step 168. For example, if the percentage trigger travel is 50% of its total travel, the pump controller 116 can operate the motor 146 at 50% motor power. As another example, if the percentage trigger travel is 100% (i.e., the trigger 140 is fully depressed), the pump controller 116 can operate the motor 146 at 100% power. Furthermore, the pump controller 116 loops back to step 154 to continuously check for overloads while operating the motor 146. In some embodiments, the pump controller 116 can operate the motor 146 at a percentage motor power that directly corresponds to the percentage travel of the variable trigger 140 (e.g., 25% trigger travel corresponds to 25% motor power). In other embodiments, the pump controller 116 can operate the motor 146 at percentage motor power intervals that correlate to the percentage travel of the variable trigger 140 (e.g., 5% intervals, 10% intervals, etc.). By way of example, operating at 10% motor power intervals can mean that 20-29% trigger travel corresponds to 20% motor power, 30-39% trigger travel corresponds to 30% motor power, etc.

Referring now to FIG. 6, FIG. 6 illustrates a closed-loop variable speed motor control method 170. Generally, the closed-loop method 170 of FIG. 6 is executed by controlling actual motor speed, e.g., in rotations per minute (RPM). The closed-loop method 170 of FIG. 6 may include similar steps initially as the open-loop method 150 of FIG. 5 and, thus, like steps are numbered accordingly. However, following step 162, if the variable trigger 140 is pressed to greater than 10% of its total travel, the pump controller 116 operates the motor 146 at a percentage motor power to achieve a desired motor speed (e.g., a set or calculated motor speed) that correlates to the percentage travel of the variable trigger 140 at step 172. The pump controller 116 then determines whether a speed error is zero at step 174. That is, the pump controller 116 determines if the actual motor speed is equal to the desired motor speed. If so, the pump controller 116 loops back to step 154 to continuously check for overloads while operating the motor 146. If, at step 174, the speed error does not equal zero, the pump controller 116 uses a proportional-integral-derivative control mechanism to update the percentage motor power (e.g., update a duty cycle of the motor 146) at step 176 in attempt to match the actual motor speed to the desired motor speed. The pump controller 116 then loops back to step 154 to continuously check for overloads while operating the motor 146.

The motor 146 (or, more generally, the power unit 106) can be operated according to the methods described herein, or other methods not specifically described here, to actuate the pump assembly 108 in order to provide pressurized fluid to the hydraulic tool 104. For example, the motor 146 can actuate the pump assembly 108 to pump fluid to the hydraulic tool 104 at an increasing fluid pressure until reaching a maximum operating pressure. The rate at which fluid pressure increases toward the maximum operating pressure can correlate to the speed at which the motor 146 is controlled as well as external loads from the hydraulic tool 104. Accordingly, by being able to vary motor speed, as described above, the pump speed can also be controlled.

With further reference to the pump assembly 108, as shown in FIGS. 1 and 4, the pump assembly 108 can include a pump 180 coupled to the power unit 106. In some embodiments, the pump 180 can be a radial pump, including a single piston and an offset cam (not shown) driven by the motor 146. For example, as shown in FIG. 4, the pump 180 can include a shaft 182 operably coupled to the motor 146. The shaft 182 converts the rotational motion of the motor 146 to linear motion of the piston. The reciprocating, linear motion of the piston withdraws fluid out of the bladder 112 and supplies pressurized fluid through the manifold 110 to the work port 122.

As shown in FIG. 4, the bladder 112 operates as a reservoir for storing hydraulic fluid (e.g., hydraulic oil). In some embodiments, the bladder 112 can include an opening 184 covered by a cap 186. The opening 184 can act as a fill port, and the cap 186 can be removed to allow for removal and/or refilling of hydraulic fluid via the opening 184. Furthermore, in some embodiments, the cap 186 or another portion of the pump housing 134 can include a transparent window 187 to allow an operator to view inside the bladder 112. As a result, the operator can quickly check a level of hydraulic fluid within the bladder 112 without having to take off the cap 186.

The bladder 112 can store the hydraulic fluid a low pressure level, such as atmospheric pressure or slightly higher than atmospheric pressure (e.g., about 30 psi to about 70 psi in some embodiments). As noted above, the pump assembly 108 withdraws fluid from the bladder 112 and forces pressurized fluid through the fluid supply line 126 into the hydraulic tool 104. Additionally, as shown in FIGS. 1 and 4, the fluid travels through the manifold 110 between the pump assembly 108, the bladder 112, and the work port 122.

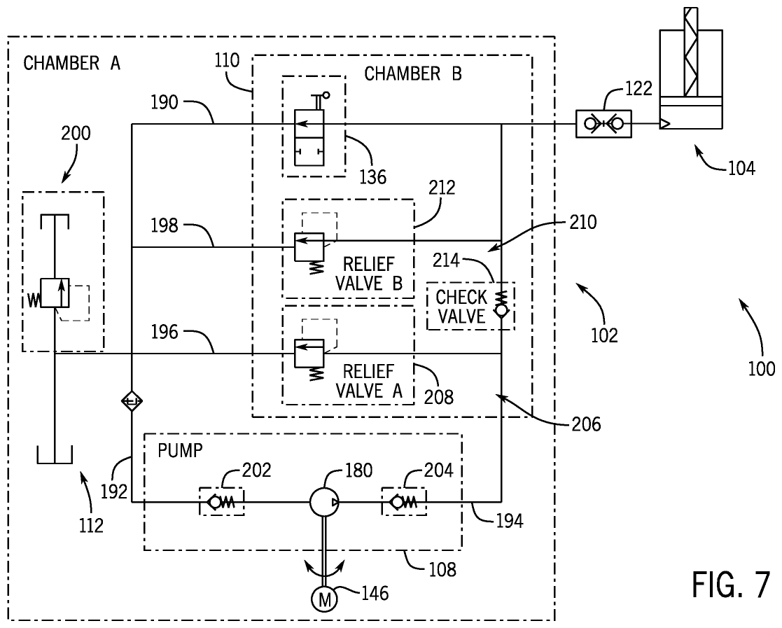

More specifically, the manifold 110 can provide fluid control, set operating pressures, and/or provide overpressure relief. For example, the manual release valve 136, accessible to an operator from outside the housing 134, can be selectively maneuvered to build fluid pressure or throttle return flow. More specifically, as shown in FIGS. 2 and 3, the release valve 136 can include a lever 188 extending from the pump housing 134 that can be moved by an operator. Internally, as shown in FIGS. 4 and 7, the release valve 136 can communicate with a fluid line 190 between the bladder 112 and the work port 122. When an operator turns the lever 188 to a first “closed” position, the release valve 136 is moved to block the fluid line 190, thereby preventing fluid from traveling from the work port 122 back to the bladder 112. This closure, in turn, allows the pump 102 to deliver pressurized fluid through the work port 122 and maintain the pressure. When an operator turns the lever 188 to a second “open” position, the release valve 136 is moved to open the fluid line 190, thereby allowing fluid to travel from the work port 122 back to the bladder 112. As a result, pressure is released and fluid returns from the hydraulic tool 104 back to the bladder 112 via the fluid line 190 (e.g., due to the spring 132 or other external force within the hydraulic tool 104 forcing the fluid out of the hydraulic tool 104).

In addition to the manual release valve 136, in some embodiments, the manifold 110 can include a relief and check valve arrangement that provides the hydraulic pump 102 with overpressure protection. More specifically, FIG. 7 illustrates a hydraulic schematic of the hydraulic power tool system 100 according to some embodiments. That is, FIG. 7 illustrates fluid connections between the bladder 112, the pump assembly 108, the manifold 110, and the hydraulic tool 104. For example, the hydraulic tool 104 includes a pump inlet line 192 between the bladder 112 and the pump assembly 108, an outlet line 194 between the pump assembly 108 and the work port 122 and extending through the manifold 110, a first manifold line 196 between the bladder 112 and the outlet line 194, a second manifold line 198 between the bladder 112 and the outlet line 194, and a third manifold line 190 between the bladder 112 and the outlet line 194.

Referring still to FIG. 7, as noted above, the bladder 112 can store hydraulic fluid at or near atmospheric pressure. In some embodiments, the bladder 112 can include a bladder overpressure release 200 to maintain pressure within the bladder 112 at or below a pressure threshold. Additionally, within the pump assembly 108, a first check valve 202 is located upstream from the pump 180, along the pump inlet line 192, and a second check valve 204 is located downstream from the pump 180, along the outlet line 194. The check valves 202, 204 can permit fluid movement from the bladder 112 through the pump 180, and prevent fluid backflow from the pump 180 to the bladder 112, thus enabling proper operation of the radial piston pump 180 to provide pressurized fluid through the outlet line 194.

Referring still to FIG. 7, the manifold 110 can contain at least a portion of the outlet line 194. Within the manifold 110, the hydraulic pump 102 can include a first chamber 206, a first relief valve 208, a second chamber 210, a second relief valve 212, an optional check valve 214, and part of the above-described manual release valve 136. Via the outlet line 194, the first chamber 206 can be connected to the pump assembly 108, the second chamber 210 can be connected to the first chamber 206, and the work port 122 can be connected to the second chamber 210 (which may further be connected to the hydraulic tool 104). The check valve 214 can be positioned along the outlet line 194 between the first chamber 206 and the second chamber 210 to permit fluid flow from the first chamber 206 to the second chamber 210 and prevent fluid flow from the second chamber 210 to the first chamber 206.

The first relief valve 208 can be connected to the first chamber 206 such that, when the first chamber 206 reaches a first pressure, the first relief valve 208 opens to permit fluid flow from the outlet line 194 back to the bladder 112 via the first manifold line 196. As a result, pressure within the outlet line 194 drops when the first pressure is reached, which can protect the pump assembly 108 from creating too much pressure within the hydraulic pump 102. Thus, the first chamber 206 and first relief valve 208 can serve as a primary pump overpressure protection mechanism.

Furthermore, the second relief valve 212 can be connected to the second chamber 210 such that, when the second chamber 210 reaches a second pressure, the second relief valve 212 opens to permit fluid flow from the outlet line 194 back to the bladder 112 via the second manifold line 198. As a result, pressure within the outlet line 194 drops when the second pressure is reached, which can protect the hydraulic pump 102 from overpressures from external loads (e.g., from the hydraulic tool 104). Furthermore, the second chamber 210 and the second relief valve 212 can serve as a secondary pump overpressure protection mechanism. For example, in some embodiments, the first relief valve 208 can be set at a lower pressure than the second relief valve 212. Therefore, if the first relief valve 208 fails, the second relief valve 212 can still relieve pump overpressure is an overpressure situation arises. In one embodiment, the first pressure is about 10,250 psi and the second pressure is about 11,500 psi. In such embodiments, the hydraulic pump 102 may be considered to be rated at 10,000 psi.

In light of the above, some embodiments provide a single acting, battery operated hydraulic pump for use with a hydraulic tool. The hydraulic pump can include a variable speed motor that is controlled via an open-loop mechanism, wherein percentage motor power is controlled, or a closed-loop mechanism, where actual pump speed is controlled through a PID control mechanism. Furthermore, the hydraulic pump can include a manifold with primary and secondary overpressure protections, which can relieve overpressures in the hydraulic pump due to pump overpressures or external overpressures.

By the term “about” or “substantially” with reference to amounts or measurement values described herein, it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide. In one example, such deviations or variations may be ±1%, ±2%, ±5% or another number.

The description of the different advantageous embodiments has been presented for purposes of illustration and description, and is not intended to be exhaustive or limited to the embodiments in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

We claim:

1. A hydraulic pump comprising:
a housing including a work port;
a bladder that stores hydraulic fluid;
a pump assembly that pumps hydraulic fluid from the bladder to the work port via an outlet line; and
a manifold containing a portion of the outlet line, the manifold comprising:
a first chamber,
a first relief valve connected to the first chamber, the first relief valve releasing fluid from the outlet line to the bladder when a first pressure is reached within the first chamber,
a second chamber located between the first chamber and the work port,
a second relief valve connected to the second chamber, the second relief valve releasing fluid from the outlet line to the bladder when a second pressure is reached within the second chamber, and
a check valve positioned along the outlet line between the first chamber and the second chamber, the check valve preventing fluid flow from the second chamber to the first chamber.

2. The hydraulic pump of claim 1, further comprising a release valve that extends into the manifold, the release valve being manually adjustable to selectively release fluid from the outlet line to the bladder.

3. The hydraulic pump of claim 2, wherein the release valve includes a lever that is accessible from outside the housing to manually adjust the release valve.

4. The hydraulic pump of claim 1, wherein the first pressure is less than the second pressure.

5. The hydraulic pump of claim 1, wherein the pump assembly includes a pump, a first pump check valve upstream from the pump between the bladder and the pump, and a second pump check valve downstream from the pump in the outlet line.

6. The hydraulic pump of claim 1, wherein the housing includes a trigger, and wherein the pump assembly pumps the hydraulic fluid from the bladder to the work port when the trigger is depressed.

7. The hydraulic pump of claim 1, further comprising a power unit that operates the pump assembly.

8. The hydraulic pump of claim 7, wherein the housing further includes a battery terminal configured to receive a removably battery that powers the power unit.

9. The hydraulic pump of claim 8, further comprising a pump controller that controls the power unit.

10. A single acting hydraulic pump comprising:
a housing including a work port;
a trigger located on the housing, the trigger configured to travel between an undepressed state and a fully depressed state by an operator;
a bladder that stores hydraulic fluid;
a pump assembly that pumps the hydraulic fluid from the bladder to the work port;
a motor that operates the pump assembly; and
a pump controller that controls a speed of the motor by operating the motor at a percentage of full motor power, the percentage of full motor power correlating to a percentage of trigger travel between the undepressed state and the fully depressed state.

11. The single acting hydraulic pump of claim 10, wherein the pump controller operates the motor at the percentage of full motor power to set a desired motor speed through a closed-loop control mechanism.

12. The single acting hydraulic pump of claim 11, wherein the closed loop control mechanism includes:
operating the motor at the percentage of full motor to achieve the desired speed,
determining whether an actual motor speed matches the desired speed, and
using proportional-integral-derivative control to update a motor duty cycle when the actual motor speed does not match the desired speed.

13. The single acting hydraulic pump of claim 10, further comprising a lock that, when actuated, prevents the trigger from being depressed.

14. The single acting hydraulic pump of claim 10, wherein the housing further includes a battery terminal configured to receive a removably battery that powers the motor.

15. The single acting hydraulic pump of claim 10, wherein the pump controller is configured to stop motor operation when the trigger is no longer depressed.

16. The single acting hydraulic pump of claim 10, wherein the pump controller is configured to stop motor operation when the percentage of trigger travel is less than about 10%.

17. A method of operating a single acting hydraulic pump, the method comprising:
determining a percentage of trigger travel between an undepressed state and a fully depressed state when an operator depresses a trigger on the single acting hydraulic pump; and
operating a pump assembly to pump hydraulic fluid from a bladder to a work port of the single acting hydraulic pump when the operate depresses the trigger, wherein operating the pump assembly includes:
controlling a motor that drives the pump assembly at a percentage of full motor power, the percentage of full motor power correlating to the percentage of trigger travel between the undepressed state and the fully depressed state.

18. The method of claim 17, further comprising:
determining a desired motor speed in relation to the percentage of full motor power;
determining whether an actual motor speed matches the desired motor speed; and
when the actual motor speed does not match the desired motor speed, updating a motor duty cycle through proportional-integral-derivative control to adjust the actual motor speed to the desired motor speed.

19. The method of claim 17, further comprising determining whether an overload exists; and power cycling the motor when the overload exists.

20. The method of claim 17, further comprising stopping the motor when the percentage of trigger travel is less than about 10%.
